(19) United States
(12) Patent Application Publication
(10) Pub. No.: US 2011/0169395 A1
(43) Pub. Date: Jul. 14, 2011

(54) LIGHT-EMITTING DIODE (LED) LIGHTING STRUCTURE

(75) Inventor: Ching Feng LIN, Taipei County (TW)

(73) Assignee: JADE YANG CO., LTD., Taipei County (TW)

(21) Appl. No.: 12/951,410

(22) Filed: Nov. 22, 2010

(30) Foreign Application Priority Data
Jan. 11, 2010 (TW) 099200523

(51) Int. Cl. H01K 1/30

(52) U.S. Cl. 313/113

(57) ABSTRACT

An improved light-emitting diode (LED) lighting structure includes a body of LED and a light reflection layer. In a preferred form of the lighting structure, the LED body includes a dual-pin through-hole LED, which has a coupling section for mounting and positioning. The light reflection layer is formed on a rear portion of the LED body and extends frontward to form a hood-like configuration for reflection of light. In an alternative form of the lighting structure, the LED body includes one or more surface-mount LEDs, each of which has electrodes respectively soldered to a circuit formed on a board. The LED body is deposited in a hood having an opening. The hood has an inside surface on which a light reflection layer is formed. As such, advantages in terms of elimination of light leakage, reduction of loss of light energy, increase of LED lighting performance, ease of use, and stability of mounting can be achieved.

### BACKGROUND OF THE INVENTION

1. Field of the Invention

The present invention is related to a light-emitting diode (LED) lighting structure, and more particular to a lighting structure that is formed of a combination of an LED and a light reflection layer, featuring elimination of light leakage, reduction of energy consumption, increase of lighting performance, ease of use, and stability of mounting, and is applicable to various LED lamps or the likes.

2. Description of Related Art

LED lamps that have been recently developed provide a significant improvement in energy saving and are considered a model for lighting in the era of energy shortage. Reference is now made to FIG. 1. In the operation of a conventional LED lamp, since a body 1 of the LED comprises an outer enclosure of light-transmitting resin package 2, most of light generated by a light-emitting chip inside the LED body 1 is guided to emit from the front end portion of the LED, but there is still a portion of the light emitting from arbitrary directions, leading the light leakage, which causes additional consumption of energy and reduction of lighting performance. Thus, the conventional LEDs do not completely meet the needs of the general consumers in practical applications. Due to the current trend of global environmental conservation, there is still much room for improving the conventional LED lamps.

### SUMMARY OF THE INVENTION

Accordingly, the primary objective of the present invention is to provide a light-emitting diode (LED) lighting structure, wherein the LED comprises a body that is in the form of dual-pin through-hole LED and a light reflection layer that is formed on a rear portion of the LED body and extending frontward to form a hood like configuration, whereby light generated by a light-emitting chip inside the LED body is reflected and directed by the light reflection layer to a front portion of the LED body in order to achieve the advantages of eliminating light leakage, reducing consumption of energy, and increasing light performance to thereby enhance the overall practicability of use.

The secondary objective of the present invention is to provide an LED lighting structure, of which the LED comprises a body that is in the form of a dual-pin through-hole LED comprising a coupling section that is configured to include a front slope portion and a rear retention portion, so as to allow the coupling section of the LED body to be coupled to a through hole defined in a board, wherein the front slope portion helps insertion of the LED body into the through hole and the rear retention portion retains the LED body in position and the front slope portion and the rear retention portion are respectively positioned against front and rear surfaces of the board to mount the LED body for forming secured coupling with the board thereby enhancing overall practicability and convenience of use.

Another objective of the present invention is to provide an LED lighting structure, of which the LED comprises a body that is in the form of a surface-mount LED having electrodes respectively soldered to a circuit formed on a board and the LED body is deposited in a hood having an opening. The hood has an inside surface on which a light reflection layer is formed, whereby when a light-emitting chip inside the LED body generates light, the light reflection layer reflects and directs the light to a front portion of the LED body for emission, so as to achieve the advantages of eliminating light leakage, reducing loss of LED lighting energy, and improving lighting performance.

A further objective of the present invention is to provide an LED lighting structure comprising bodies of LED in the form of surface-mount LED having electrodes respectively soldered to a circuit formed on a board. The LED bodies are respectively deposited in openings of a hood module. The hood module is an integrated combination of hoods respectively receiving the LED bodies therein. The hood module has inside surfaces where lights from the LED bodies irradiate respectively and each of the inside surfaces forms a light reflection layer, whereby the LED lighting structure allows for efficient assembling of the hood module to effectively eliminate light leakage, reduce loss of LED lighting, and improve overall functionality of use and convenience of assembling.

In order to achieve the foregoing objectives, the present invention provides a light-emitting diode (LED) lighting structure, which comprises a body of LED and a light reflection layer. In one form, the LED body is a dual-pin through-hole LED, which has a coupling section for mounting and positioning. The light reflection layer is formed on a rear portion of the LED body and extends frontward to form a hood-like configuration for reflection of light. In an alternative form, the LED body is a surface-mount LED, which has electrodes respectively soldered to a circuit formed on a board. The LED body is deposited in a hood or a hood module having an opening. The hood or hood module has an inside surface on which a light reflection layer is formed. As such, the two above-mentioned forms of LED body is arranged in combination with a light reflection layer to thereby achieve the advantages of elimination of light leakage, reduction of loss of light energy, increase of lighting performance, ease of use, and efficiency and stability of mounting so as to enhance overall practicability and convenience.

### BRIEF DESCRIPTION OF THE DRAWINGS

The present invention can be fully understood from the following detailed description and preferred embodiment with reference to the accompanying drawings, in which:

FIG. 1 is a schematic view illustrating a conventional light-emitting diode (LED) in use;

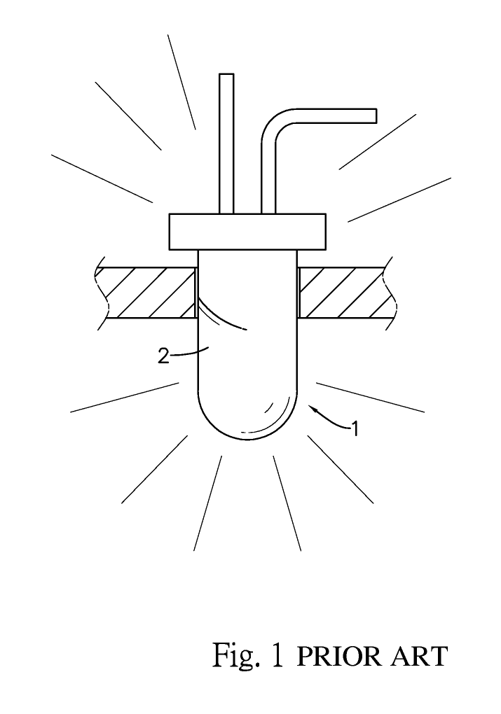

FIG. 2 illustrates a perspective view of an LED lighting structure according to a first embodiment of the present invention;

FIG. 3 also illustrates a perspective view of the LED lighting structure according to the first embodiment according to the present invention, but taken from a different viewing angle;

FIG. 4 is a schematic view illustrating the LED lighting structure according to the first embodiment of the present invention in use;

FIG. 5 is a schematic view illustrating an LED lighting structure according to a second embodiment of the present invention in use; and

FIG. 6 is another schematic view illustrating the LED lighting structure according to the second embodiment of the present invention in use.

### DETAILED DESCRIPTION OF THE PREFERRED EMBODIMENTS

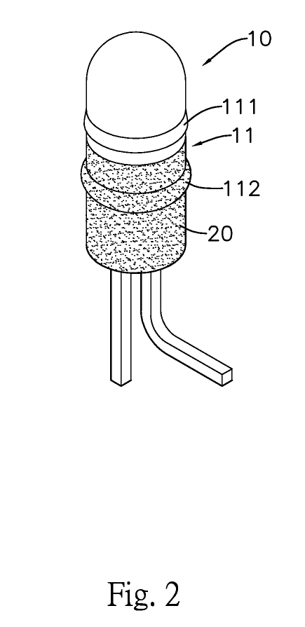

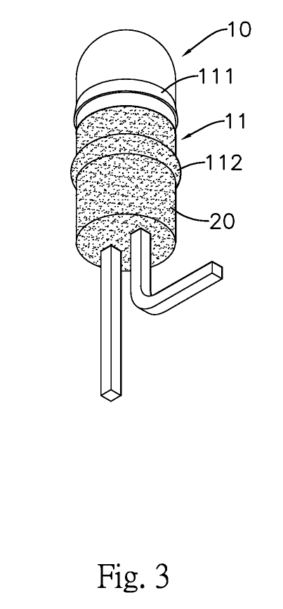

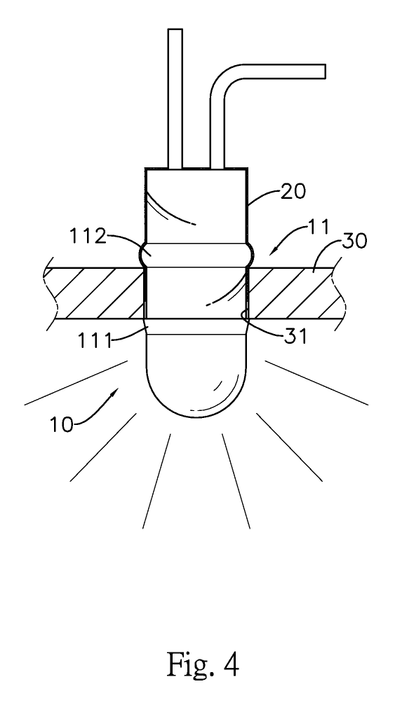

Referring to FIGS. 2-4, the present invention provides a light-emitting diode (LED) lighting structure, which comprises constituent components described below.

A body 10 of the LED according to a first embodiment of the present invention is in the form of a dual-pin through-hole LED. The LED body 10 comprises a mounting section 11 for positioning and mounting of the LED. The mounting section 11 of the LED body 10 forms a front slope portion 111 and a rear retention portion 112. The front slope portion 111 functions for positioning of the LED body in inserting of the LED body, while the rear retention portion 112 functions to stop and thus retain the LED body in position.

A light reflection layer 20 is formed on a rear portion of the LED body 10 and extends frontward. The light reflection layer 20 forms a hood-like configuration for reflection of light. The light reflection layer 20 can be a metallic light reflection layer. Preferably, the light reflection layer 20 is formed by electroplating or coating.

The mounting section 11 of the LED body 10 is further coupled to a board 30. The board 30 forms a through hole 31 corresponding to the LED body 10 for receiving the LED body 10 to insert therethrough and position therein. The front slope portion 111 and the rear retention portion 112 of the mounting section 11 are respectively positioned against front and rear surfaces of the board 30.

The above description provides an LED lighting structure and as shown in FIGS. 2-4, the LED structure of the present invention features a combination of an LED body 10 and a light reflection layer 20, wherein the light reflection layer 20 is formed on a rear portion of the LED body 10 and extends frontward and the light reflection layer 20 forms a hood-like configuration for reflecting and directing light generated by a light-emitting chip inside the LED body 10 to a front portion of the LED body so as to achieve the advantages of eliminating light leakage, reducing consumption of energy, and increasing lighting performance thereby enhancing overall practicability of use. Further, with the front slope portion 111 and the rear retention portion 112 provided on the mounting section 11 of the LED body 10, when the mounting section 11 of the LED body 10 is inserted through and thus coupled to a through hole 31 defined in a board 30, the front slope portion 111 helps and guides the insertion of the LED body through the through hole 31 of the board 30 and the rear retention portion 112 functions to stop and thus retain the LED body in position. The front slope portion 111 and the rear retention portion 112 of the mounting section 11 are respectively positioned against front and rear surfaces of the board 30 for positioning the LED body 10 inserted in the through hole 30, whereby a secured coupling can be formed between the board 30 and the LED body to thereby enhance overall functionality and convenience of the present invention.

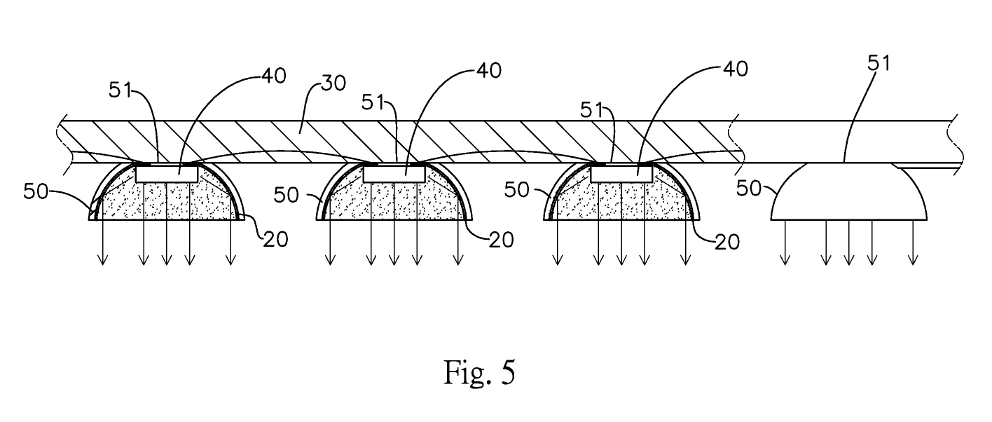

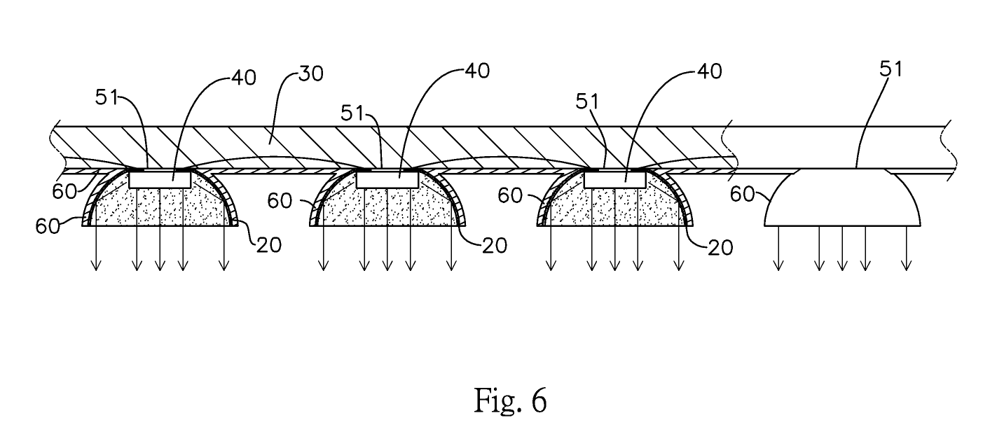

Referring to FIGS. 5 and 6, an LED lighting structure of the present invention is shown. The LED lighting structure is composed of the constituent components that will be described.

A body 40 of the LED according to a second embodiment of the present invention is in the form of a surface-mount LED. The LED body 40 comprises electrodes that are respectively soldered to portions of a circuit formed on a board 30, which in the embodiment illustrated comprises a plurality of LED bodies 40 soldered thereto. Each of the LED bodies 40 is deposited in a hood 50 having an opening 51.

A light reflection layer 20 is formed on an inside surface of each hood 50 where light from the LED body 40 irradiates, whereby light generated by a light-emitting chip inside the LED body 40 can be reflected and directed by the light reflection layer 20 to a front portion of the LED body 40 for emission. The light reflection layer 20 can be a metallic light reflection layer. Preferably, the light reflection layer 20 is formed by electroplating or coating.

Moreover, the LED bodies 40 are respectively deposited into the hoods 50 through the openings thereof. The hoods 50 can be integrally formed together to form a hood module 60 with the light reflection layers 20 being formed inside surfaces of the hood module 60 where lights from the LED bodies 40 respectively irradiate. In this way, the hood module 60 can be formed as a one-piece member and allows for efficient assembling. The light reflection layers 20 that are formed on the inside surfaces of the hood module 60 can be formed by for example electroplating or coating to provide an LED lighting structure that achieves the advantages of effectively eliminating light leakage, reducing loss of light energy from the LED bodies 40, and increasing lighting performance, thereby enhancing overall functionality of use and convenience of efficient assembling.

What is claimed is:

1. A light-emitting diode (LED) lightings structure comprising:
an LED body, which forms a coupling section for mounting and positioning; and
a light reflection layer, which is formed on a rear portion of the LED body and extends frontward to form a hood-like configuration for reflection of light.

2. The LED lighting structure according to claim 1, wherein the coupling section of the LED body forms a front slope portion for positioning and inserting the LED body and a rear retention portion for stopping and retaining the LED body in position.

3. The LED lighting structure according to claim 2, wherein the coupling section of the LED body is coupled to a board, which forms a through hole corresponding to the LED body for receiving the LED body to insert therethrough and position therein, the front slope portion and the rear retention portion of the coupling section being respectively positioned against front and rear surfaces of the board.

4. The LED lighting structure according to claim 1, wherein the light reflection layer comprises a metallic light reflection layer.

5. The LED lighting structure according to claim 4, wherein the light reflection layer is formed by electroplating.

6. The LED lighting structure according to claim 4, wherein the light reflection layer is formed by coating.

7. The LED lighting structure according to claim 1, wherein the LED body comprises a dual-pin through-hole LED.

8. A light-emitting diode (LED) lighting structure comprising:
LED bodies, each of which comprises electrodes respectively soldered to portions of a circuit formed on a board, the LED bodies being respectively deposited in hoods each of which has an opening; and
a light reflection layer, which is formed on an inside surface of each hood where light from the respective LED body irradiates.

9. The LED lighting structure according to claim 8, wherein the hoods are combined together as a hood module.

10. The LED lighting structure according to claim 9, wherein the light reflection layers are formed on inside surfaces of the hood module where lights from the LED bodies respectively irradiate.

11. The LED lighting structure according to claim 8, wherein the light reflection layers comprise metallic light reflection layers.

12. The LED lighting structure according to claim 10, wherein the light reflection layers comprise metallic light reflection layers.

13. The LED lighting structure according to claim 9, wherein the hood module is integrally formed as a one-piece member.

14. The LED lighting structure according to claim 8, wherein the light reflection layers are formed by electroplating.

15. The LED lighting structure according to claim 10, wherein the light reflection layers are formed by electroplating.

16. The LED lighting structure according to claim 8, wherein the light reflection layers are formed by coating.

17. The LED lighting structure according to claim 10, wherein the light reflection layers are formed by coating.
